(19) United States
(12) Patent Application Publication
(10) Pub. No.: US 2025/0312237 A1
(43) Pub. Date: Oct. 9, 2025

(54) Dry needle holster and insertion device

(71) Applicant: DRY NEEDLING INNOVATION SYSTEMS, LLC, Galesville, WI (US)

(72) Inventors: Dana Halderson, Galesville, WI (US); Laura McCormick, Ann Arbor, MI (US); Nathaniel Johnson, Ypsilanti, MI (US); Kegan McArthur, Saline, MI (US); Gene Parunak, Saline, MI (US); Sarah Kaczmarek, Plymouth, MI (US); Adrienne Harris, Clinton, MI (US)

(21) Appl. No.: 19/169,609

(22) Filed: Apr. 3, 2025

Related U.S. Application Data
(60) Provisional application No. 63/574,361, filed on Apr. 4, 2024.

(51) Int. Cl. A61H 39/08

(52) U.S. Cl. CPC A61H 39/083; A61H 2201/0153; A61H 2201/0176; A61H 2201/10; A61H 2201/12; A61H 2201/5053

(57) ABSTRACT

A handheld device and method for self dry needling using the device comprising a dry needle outlet end; a needle priming cavity aligned with an outlet of the needle outlet end and configured to receive a dry needle therein for dispensing; a needle ejection mechanism comprising a driver configured to eject the dry needle from the needle priming cavity through the needle outlet upon actuation of the needle ejection mechanism; and a needle storage cavity configured to hold one or more additional dry needles comprising a needle loading mechanism configured to transfer one or more needles from the storage cavity to the needle priming cavity upon actuation of the needle loading mechanism.

### CROSS-REFERENCE TO RELATED APPLICATION

This application claims priority to and the benefit of U.S. provisional patent application Ser. No. 63/574,361, filed Apr. 4, 2024, the contents of which are incorporated herein in their entirety.

### BACKGROUND

Musculoskeletal pain results from repetitive movement or injury to a body part such as the forearm, shoulder, thigh, lower leg and/or foot. This causes pain and discomfort, and disrupts the activities of a person's daily life.

Dry needling is a method of relieving pain associated with repetitive movements and/or other injury. Generally, dry needling is carried out by physical therapists, chiropractors or other clinicians and is done in-office. Clinicians use dry needling to resolve musculoskeletal pain.

Because healthcare system clinicians currently perform dry needling, limited access to healthcare and high costs prevent many people from obtaining such services.

### DESCRIPTION OF THE DRAWINGS

FIG. 1 is a cross-sectional view of a handheld dry needling device according to one or more embodiments described herein.

FIG. 2 is a perspective view of a needle cartridge for use with a handheld dry needling device according to one or more embodiments described herein.

FIG. 3 is a cross-sectional view of another embodiment of a handheld dry needling device according to one or more embodiments described herein.

FIG. 4 is front perspective view of another embodiment of a handheld dry needling device according to one or more embodiments described herein.

FIG. 5 is a cross-sectional view of the handheld dry needling device illustrated in FIG. 4.

FIGS. 6A-6E illustrate embodiments of a driver mechanism for providing drive force for dispensing a needle from a handheld dry needling device according to any one or more embodiments described herein.

FIGS. 7A-7C illustrate embodiments of a driver mechanism for engaging a needle for dispensing the needle from a handheld dry needling device according to any one or more embodiments described herein.

FIGS. 8A-8E illustrate embodiments of an actuator for dispensing a needle from the handheld dry needling device and/or loading a second needle for dispensing from the handheld dry needling device according to any one or more embodiments described herein.

FIGS. 9A-9C illustrate embodiment of the handheld dry needling device according to any one or more embodiments described herein with an actuator for dispensing a needle and an actuator for loading a subsequent needle.

FIGS. 10-10C illustrate a handheld dry needling device having a spring-loaded mechanism for dispensing and loading needles.

FIGS. 11A-11B illustrate primary mechanisms for limiting dispensing depth of a needle wherein FIG. 11A illustrates a dial and FIG. 11B illustrates a slider.

FIGS. 12A-12B illustrate secondary depth adjustment mechanism for devices according to one or more embodiments described herein wherein FIG. 12A illustrates a rotational device for fine adjustment of speed of needle deployment and FIG. 12B illustrates a damper for limiting for speed of needle deployment from a device.

FIGS. 13A-13B illustrate a lock for preventing dispensing or deployment of a need from a device according to one or more embodiments described herein.

FIGS. 14A-14C illustrate mechanisms for maintaining sterility of needles for use with the device according to one or more embodiments herein. FIG. 14A illustrates a sterile sealed cartridge loadable into a device, FIG. 14B illustrates a cavity holding sterile needles provided with or without a sheath and having a rubber or foil pierceable septum for maintaining sterility until deployment, and FIG. 14C illustrates a rubber or silicon closure having a slot which can be opened by way of manual force, allowing a needle to leave the sterile environment via exiting through the slot.

FIGS. 15 and 16 illustrate a device according to one or more embodiments described herein and further comprising capability to provide vibration, heat or electrical pulses to a needle by way of contact with an end of the needle.

### SUMMARY OF THE INVENTION

An aspect of the present disclosure relates to a hand-held device for holding one or more dry needles. The device holds the needles for use, and upon actuation, ejects a needle for inserting the needle into a target location on a user. The dry needles are generally used for intramuscular therapy, acupuncture or similar therapies where a needle is inserted into a location on a user, such as a muscle group, and remains in place for a therapeutic time, ranging from a few seconds, to minutes to half an hour or longer as needed. The device and the needles therefore may also be used for insertion in to scars, scar tissue, adhesions and other areas of trauma, pain, or healing on a user. In one embodiment, the device is configured to control depth of insertion to allow a user to self-administer dry needle therapy on their own and/or at home. In another embodiment, the user is allowed to control the depth of the insertion rather than the device having a depth control mechanism. The device can be used alone or in combination with other dry needling aid such as patches or sleeves which provide a user indications of target locations for therapy and guide the user to insertion locations for safety and efficacy and/or with aids to provide an indication of depth limits for insertion. The device may be configured with adjustable settings including needle insertion depth, a maximum depth limit, needle ejection force or combinations thereof.

An aspect of the present disclosure relates to a device for holding a plurality of dry needles, the device comprising an inlet and an outlet, with a length therebetween, a plurality of holding mechanisms, each for holding a dry needle therein, a mechanism for aligning one of the holding mechanisms holding a dry needle with the outlet of the device, a plunger mechanism for linearly displacing the holding mechanism and dry needle held therein a pre-selected distance, wherein the pre-selected distance is greater than a distance between an end of the dry needle and the outlet such that the dry needle is ejected from the device through the outlet, and wherein the holding mechanism is configured to release the needle from the holding mechanism after actuation of the plunger mechanism. In such embodiments, a user can control the depth of insertion of the needle ejected from the device and may further adjust depth independently after removal device from a top or end of the needle ejected.

Another aspect of the present disclosure relates to a handheld device for dispensing a plurality of dry needles, the device comprising a dry needle outlet end; a needle priming cavity aligned with an outlet of the needle outlet end and configured to receive a dry needle therein for dispensing; a needle ejection mechanism comprising a driver configured to eject the dry needle from the needle priming cavity through the needle outlet upon actuation of the needle ejection mechanism; and a needle storage cavity configured to hold one or more additional dry needles comprising a needle loading mechanism configured to transfer one or more needles from the storage cavity to the needle priming cavity upon actuation of the needle loading mechanism.

Another aspect of the present disclosure relates to a method of using a device for injecting a dry needle into the skin for self-needling, the method comprising providing a hand-held device storing one or more dry needles therein; placing the device over a target location on a user; ejecting one of the one or more dry needles from the hand-held device into a user's skin; and removing the hand-held device from the target location on the user and leaving the needle behind.

In any one or more of the embodiments described herein, the device stores one or more, or for example, at least five needles therein and the use further comprises advancing a subsequent needle for dispensing concurrently or after the ejecting of one of the one or more dry needles.

In any one or more of the embodiments described herein, the device is configured with a heat source, vibration source, and/or source of electrical pulse which allows the device to apply heat, vibration and/or electrical pulses to the one or more dry needles dispensed therefrom and inserted into a user.

The user may be provided with a kit including tools for determining a depth for insertion of the needle into the user as well as additional needles and/or accessories for sterilization and sanitization. In some embodiments the device may further comprise a limiter to limit a linear distance for ejection of one of the one or more dry needles from the hand-held device.

### DETAILED DESCRIPTION

A device according to one or more embodiments described herein is provided to aid a user in self-administration of dry needling therapy. The device allows a user to confidently, safely, and effectively place dry needles sub-dermally for desired therapeutic effects. The device is configured to hold one or more needles and may be configured with adjustable depth and/or ejection force settings for placement of a dry needle tip in the users skin. The device is configured to hold or receive one or more needles, eject one or more needles for insertion and/or placement, and optionally in one or more embodiments remove and/or dispose of the needle from the user. The device is configured to be used alone and/or in combination with other self-administration and self-needling aids such as patches or sleeves which provide a user indications of target locations for dry needle therapy and guide the user to insertion locations for safety and efficacy.

The device described herein may be a combination needle holder and needle insertion device, specifically for dry needles, acupuncture needles or the like. The device may hold one or a plurality of dry needles concurrently. Additionally or alternatively, the device may be configured to receive a supply of needles from a cartridge storing one or more needles. The device may also have one or more mechanisms for deploying a needle for penetration and sub-dermal placement into a target area on a user. The device may be configured with adjustable settings including needle insertion depth and/or needle ejection force or otherwise be provided with indicators and/or mechanisms which allow the user to control or select an insertion depth and/or ejection force.

The needles suitable for use with the device described herein may be dry needles, acupuncture needles, or other therapeutic needles which penetrate the skin into a muscle, scar, wound, adhesion, or any other subdermal tissue. The needles may be dry needles which are generally solid needles, not for delivery of fluids or the removal of fluids. However, the devices described herein are not limited to use with solid needles and could be adapted for use with hollow needles. Moreover, the needles may be comprised of any material suitable for placement in the user's skin, for example subdermal placement in a target area of user such as stainless steel, as well as silver, titanium or copper. Other materials suitable for dermal, subdermal or subcutaneous insertion and placement are also contemplated and within the scope of this disclosure. The term dry needle is used throughout the disclosure, but application is not so limited.

The device described herein is configured to dispense or deploy a needle therefrom. In some embodiments, the needle is deployed and inserted into the skin at a target area selected by the user. The needle may penetrate the skin and remain in the epidermis and/or dermis, subcutaneously, and/or in a muscle, and/or to a depth selected by the user and/or the depth being a therapeutic depth as disclosed further in this specification. The needle(s) deployed by a device according to one or more embodiments described herein may penetrate and/or rest in the body, such as through the skin, in a dermal, subdermal layer of the skin or subcutaneous tissues, muscle or deeper for example. In one or more embodiments described herein, the device is configured to and capable of deploying a needle from the device, through a user's skin and at least partially into the user's body where the needle can remain for a period of time lasting from one or more seconds to one or more minutes.

The device described herein is a handheld device which can be loaded with one or more dry needles concurrently or successively. The device may be configured to hold four, five, or six needles or more for use and/or a cartridge may be provided that holds four, five or six needles or more for use. Cartridges may include a single use or reloadable cartridge for retaining and indexing sterile needles for dispensing with the device. Additional or alternative embodiments include linear indexing holders of various dimensions and shapes; a multi-needle click-pen style device where each needle has a dedicated plunger or actuator and wherein each actuator may be provided with a distinct marking such as color, number or the like; as well as a box-type magazine with a spring/follower mechanism for indexing to subsequent needles for dispensing from the device. The cartridges of one or more embodiments described herein may be pre-loaded, reloadable, single or multi use cartridges and as such needles may be provided with the cartridge or separately forming a kit.

In one or more embodiments, the device holds the needles concurrently and a user may select which needle in the device holder is to be deployed by the device and/or the device may be configured to automatically advance a subsequent needle for insertion, allowing for placement of a plurality of needles without reloading the device. A holster supporting a plurality of needles may be slidably or rotatably provided in or with the device and manually or automatically advanced to bring a subsequent needle to a position in the device for deployment of the dry needle.

Additionally or alternatively, the device may be configured to hold one or a plurality of needles, while a user manually loads a target dry needle into an insertion chamber for deploying the dry needle into the target area on the user. The user may then manually move each dry needle to the insertion chamber when ready for use.

The device may further be provided with one or more mechanisms for deploying a needle from the device. For example, the device may be spring loaded and/or provided with a plunger device that clamps around a needle to grab the needle and drive the needle outwardly from the device for use. Drive force mechanisms may include a coil spring, a constant force spring, magnets which allow for deployment in a controlled manner, a manual plunger for manual ejection of the needle, a leaf spring, a drive wheel assembly or the like. For example, where a drive wheel assembly is utilized to push the needle downwardly for ejection, the drive wheel or wheels may have a textured surface to engage via grip, friction or force with a length of the needle. As the drive wheel is rotated, linear movement is transferred to the needle. The drive wheel for example could be activated by a switch, lever or dial.

The device may be provided with a trigger or other actuation mechanism for deployment of the needle. For example, a thumb button or side button may be provided on the handheld device although knobs, levers, triggers and dials are also contemplated and within the scope of this disclosure. Moreover, the device may be configured for double action or single action activation. That is, one mechanism may be provided that ejects and/or dispenses the needle and loads the next needle or two mechanisms may be provided where each mechanism is a single purpose mechanism for dispensing or loading (or reloading). For example, double action mechanisms for concurrent loading and dispensing can include a stapler mechanism where a single action both actuates dispensing of one needle and loading of a second needle.

The button, switch, lever, or other mechanism may be operably provided to activate linear displacement of one or more needles and optionally a pre-determined distance. The mechanism may automatically advance to a subsequent needle, a subsequent needle may automatically advance to the mechanism, or a user may load a subsequent needle in line with the mechanism. An additional lever or button may be provided such that the device includes a first mechanism for actuating drive force for ejecting of the needle and a second mechanism for advancing a subsequent needle to a delivery position for ejecting.

The distance in which the needle will be deployed may be adjusted for each dry needle. A dial or a slider may aid in controlling the depth of the needle as dispensed. The device may be provided with a primary and/or secondary mechanism to control the distance of linear displacement of the needle (e.g., depth of insertion). Once the needle has been displaced, or ejected the selected distance from the device, the mechanism for driving the needle outward from the device releases the needle, allowing the user to lift the pen away from the needle while a length of the needle remains inserted in the user for therapeutic purposes.

Depth adjustment and/or selection may also optionally be controlled manually, via a limiting mechanism for limiting speed and/or ejection force of the needle. More specially one or both of a velocity limiter and speed limiter may be operably incorporated into the device to control or limit the velocity and speed of the downward dispensing of the needle. Additionally or alternatively, attachments may be provided which space the target area of the user from the outlet of the device in order to control depth. For example, a spacer can be secured to the device to reduce insertion depth when used and removed to increase insertion depth. The spacer may come in different sizes or be adjustable. Alternatively, the device housing itself may have a variable length to also adjust the space between the needle in the device from the target area such that depth can be controlled. The user may also control depth and/or placement of needles during insertion and/or via adjustment after deployment of the needle.

The device may have an insertion chamber, configured to receive or hold the needle that is to be deployed (ejected) from the device into the user. The insertion chamber may have an open top to allow for use of dry needles of various lengths or may have a length greater than a length of the dry needle(s) loaded therein. The device is thus configured such that, as the needle is displaced downwardly into a user's skin, the device can remain held in place against the user's skin or against a device worn by the user to direct the needle to a target area. When the needle is sufficiently placed sub-dermally and/or at the depth pre-selected by the user, the needle is released from the device and the device can be manually lifted upwardly or otherwise moved to release the dry need allowing the dry needle to remain placed in the user. A portion of the device may have a clear window allowing a user to see the needle position within the device before, during, or immediately after ejection.

Additionally or alternatively, the device may have a placement mechanism surrounding a needle outlet of the device and which pushes the device away from the user's skin and/or needle placement aid, as the needle is inserted into the user. Once the needle is displaced the selected distance from a holding position inside the device, the device releases the needle so that the device can be moved to another location or insertion of another dry needle.

In one or more embodiments, the device may also comprise one or more safety mechanisms. For example, one or more sensors may be incorporated such that contact with a user's skin or other target area must be made before a needle can be dispensed. Such sensors may be optical sensors, electrical sensors, contact sensors, capacitive touch sensors or the like. Other mechanisms may be incorporated which control a maximum travel limit for the needles dispensed or otherwise limit force of dispensing the need such as a mechanical or magnetic disconnect. The device may also be provided with a locking mechanism positioned near the needle outlet. The locking mechanism may be a mechanical element which must be displaced to allow for a needle to be dispensed. For example, the lock may be an element extending from the outlet area of the device where the lock is depressed against the target area to unlock the needle outlet. Additionally or alternatively a lock may be provided on the device that must be unlocked manually with a button, trigger or other element when ready to dispense a needle therefrom.

The needle(s) usable with the device according to one or more embodiments described herein may be induvial, sterile needles for loading into the device or may be a plurality of sterile needles provided in a sealed cartridge that is loaded into the device for use.

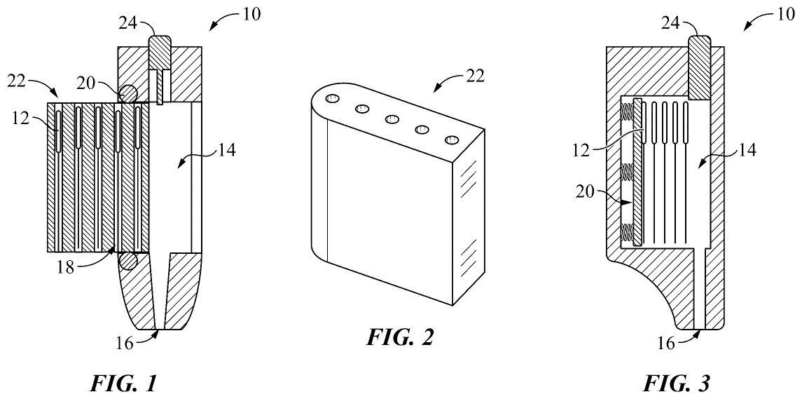

Embodiments of the handheld device, components thereof and its use are illustrated in FIGS. 1-16.

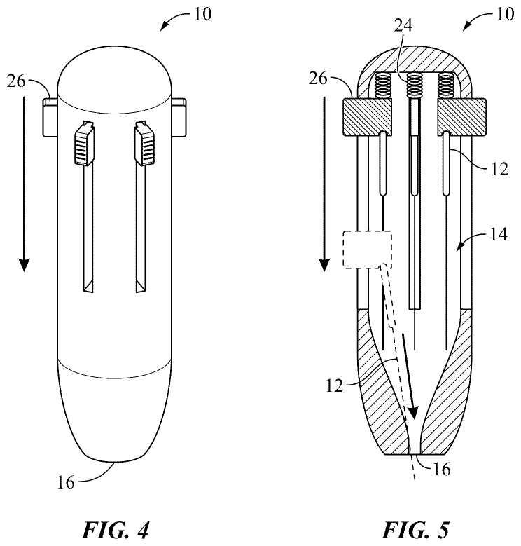

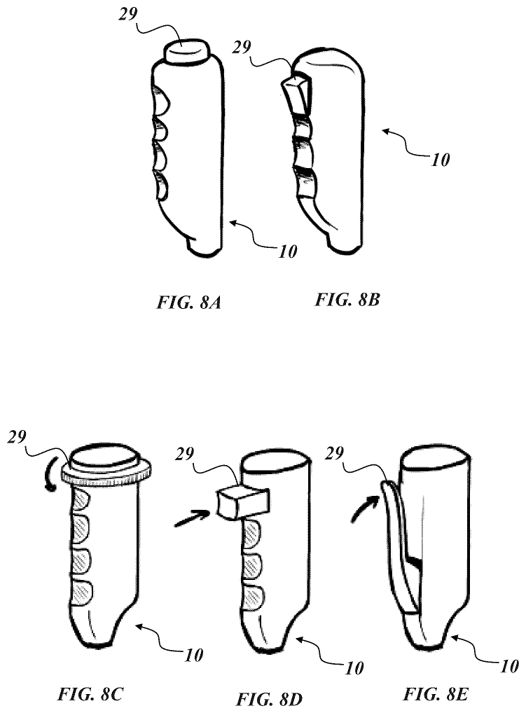

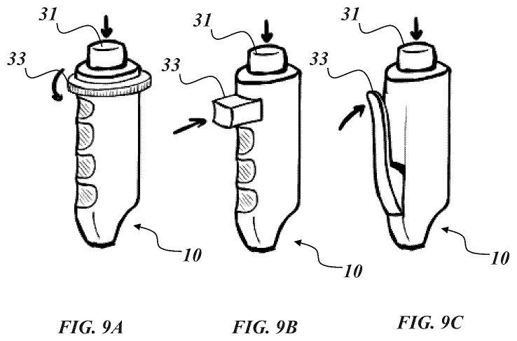

In one embodiment as illustrated in the figures, and for example, FIGS. 1-5, the device may be a self-contained hand held device 10 wherein a plurality of sterile needles 12 are loaded into the device 10 before use. The device 10 includes a needle priming cavity 14 which positions and retains a first dry needle 12 for ejection. The needle priming cavity 14 is generally aligned with an outlet 16 of the device wherein the needle 14 is ejected or dispensed from the outlet 16. The outlet 16 may be provided with a guide for positioning the outlet over a target area and/or spacing the outlet 16 from the target location on the body of the user. Adjacent the needle priming cavity 14 is a needle loading cavity 18 which holds additional needles for loading one by one into the needle priming cavity. The needle loading cavity 18 is provided with a loading mechanism 20 which is activated to load a needle 12 into the needle priming cavity 14. The mechanism 20 as illustrated in FIG. 2 comprises a spring loaded plate for loading the needle(s) 12. As illustrated in FIG. 4, the loading mechanism 20 comprises a rotating drum which indexes the needles to the needle priming cavity (and/or indexes the needle dispensing mechanism or driver to the needle). Moreover, the loading mechanism 20 as illustrated in FIGS. 8A-9C can be manually actuated by way of button, knob, dial, lever, trigger or the like.

In another embodiment, as illustrated in FIGS. 1 and 2, the device is a handheld device 10 that wherein the needle lading cavity comprises a removable cartridge 22 which is preloaded with one or more, for example, five sterile dry needles. The cartridge 22 is disposable and is loadable into the device 10 and the needle loading mechanism 20 may linearly or rotatably index through the device 12 or linearly or rotatable index needles through the cartridge 22 in order to deliver needles 12 through openings in the cartridge 22 to the needle priming cavity 14.

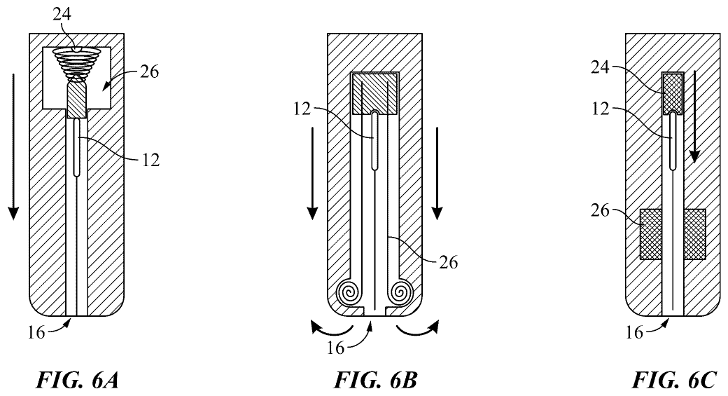

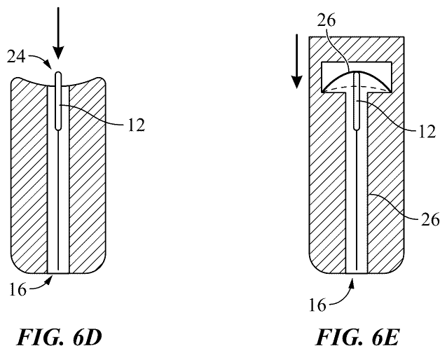

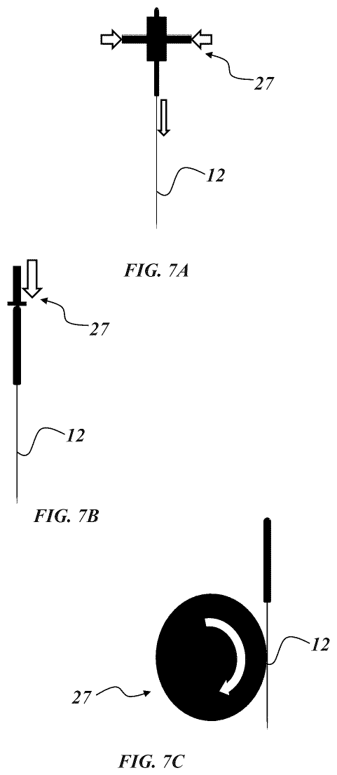

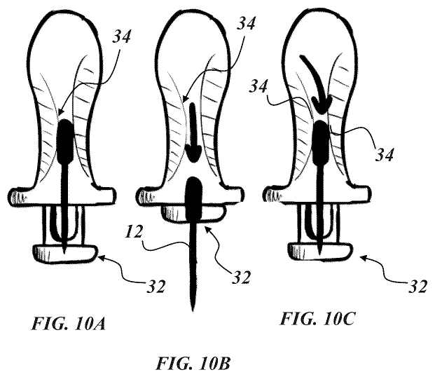

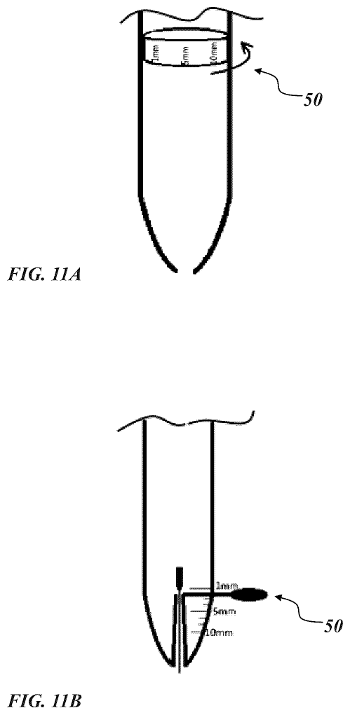

In one or more embodiments described herein a needle dispensing mechanism 24 is provided in the device which is actuated to eject the needle from the inside of the device 10 through the outlet 16 and into the target area of the user. The needle dispensing mechanism(s) 24 comprises a manually actuated driver(s) 26 to provide force for dispensing or deploying the needle. Nonlimiting examples of drivers 26 are illustrated in FIGS. 6A-6E and engagement mechanisms 27 for the dispensing mechanism 24 are correspondingly illustrated in FIGS. 7A-7C. However, it is contemplated and within the scope of this disclosure that the driver could be electrically actuated and the device battery operated or otherwise powered. The needle dispensing mechanism 24 as illustrated in FIGS. 8A-8E and 9A-9C as well as FIGS. 10A-10C can be manually actuated via a an actuator 29 such as a button, knob, dial, lever, trigger or other actuation device for transferring force from the actuator to the driver 26. As shown in FIGS. 8A-8E, a single mechanism 29 may actuate both dispensing of a needle and loading of a subsequent needle concurrently and/or in quick succession. Alternatively, as shown in FIGS. 9A-9C, two actuators are used, one for deployment of a needle 31 and one for loading of subsequent needles 33.

The driver 26 may drive or depress the needle 12 itself with sufficient force to disengage the needle 12 from a surface or holder in the needle priming cavity 14 which retains the needle 12 therein or depress a holder for the needle that releases the needle 12 therefrom when fully depressed allowing the ejected needle to remain outside and/or free of the housing.

In the embodiment as illustrated in FIGS. 10A-10C, a guide 32 surrounds the outlet 16 of the device 10 and spaces the needle 12 in the needle priming cavity 14 away from the target area. This guide also is spring loaded and serves to engage the needle for deployment and allow for loading of a second needle 12. The needle 12 is held in the needle priming cavity via one or more, for example, opposing surfaces 34 in the needle priming cavity which frictionally engage an upper portion of the needle which has a wider diameter than the lower portion of the needle 12 which penetrates the user's skin. When the device 10 is pushed downward the needle 12 is forced into the skin and the guide 32 retracts into the needle priming cavity 14 and displaces the surfaces 34 in the cavity 14 to release the needle 12 such that the needle 12 is then ejected from the device 10. The guide 32 is spring loaded and then returns to a primed state as a second needle is dropped into the space between surfaces 34 and engaged when the guide is released.

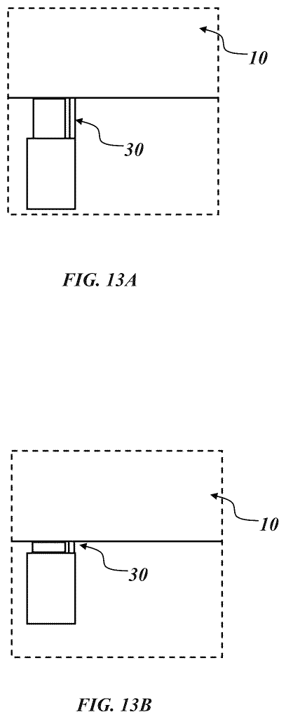

As illustrated in FIGS. 13A-13B, the device 10 according to one or more embodiments described herein may further comprise a lock 30. The lock 30 can be engaged to prevent the dispensing of a dry needle 12 and disengaged to dispense the needle 12. The lock 30 may be provided on the device 10 and configured to prevent actuation of the driver 26 and/or engagement of the actuator for the driver 26. In one embodiment, the lock 30 is provided near the outlet 16 of the device and is depressed to disengage the lock 30 from the needle dispensing mechanism 24 by pressing the outlet 16 of the device 10 and thus the lock 30 against the target area of the user. Alternatively, the device 10 may be unlocked by way of one or more sensors.

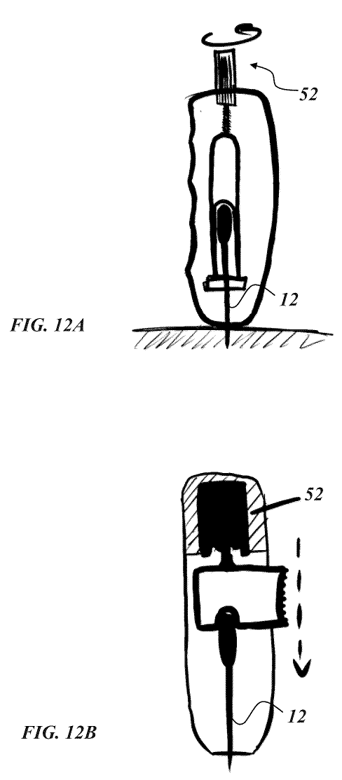

In any one or more of embodiments of device 10, the device may further include a primary or primary and second mechanism for limiting conditions of needle dispensing or deployment. For example, the primary mechanism may be used to limit the dispensing depth of the needle. FIG. 11A illustrates a dial which is rotatable to limit the depth of deployment. In many embodiments the depth into the user is generally between about 1 mm and 3 mm or less than about 4 mm. FIG. 11B illustrates a slider mechanism for limiting the depth in which a needle deployed can penetrate the skin. These are primary limiting mechanisms 50. Secondary limiting mechanisms 52 are also optional and may be used to limit the speed of the needle during deployment or dispensing. For example, as illustrated in FIG. 12A the speed limiting mechanism may comprise a rotational device for fine adjustment of the speed of needle deployment or as illustrated in FIG. 12B the device 10 may comprise a damper for limiting for speed of needle deployment from a device.

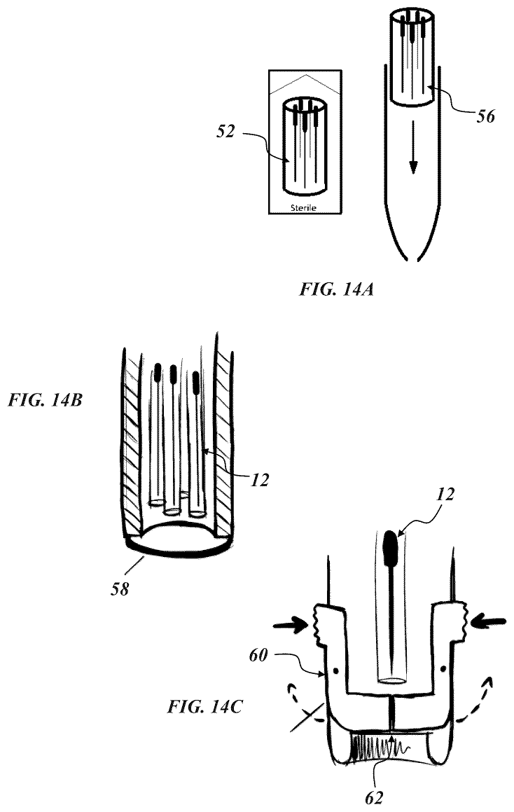

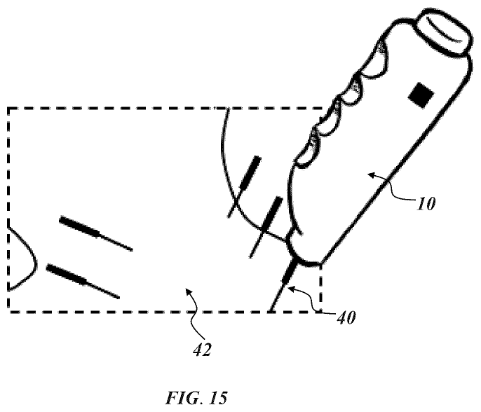

Device 10 according to any one or more of the embodiments described herein may be configured for use with sterile needles and may be configured to maintain sterility of the needles until use of the device. As shown in FIG. 14A a sterile sealed cartridge 56 may be provided and is preloaded or otherwise loadable into a device 10. The sterility seal is broken during deployment of needles. FIG. 14B illustrates a cavity holding sterile needles provided with or without a sheath and having a rubber or foil pierceable septum 58 for maintaining sterility until deployment of the needle 12. FIG. 14C illustrates a rubber or silicon closure 60 having a slot 62 which can be opened by way of manual force, allowing a needle to leave the sterile environment via exiting through the slot.

To use the device, a user may first select a muscle or muscle group for self-administering dry needling and optionally proceed to obtain a measurement specific to the area in which the dry needle will be used for therapy. The measurement may be a BMI, height, weight, size or other measurement related to the area for needle insertion. For example, if the location for therapy and insertion of the needle is positioned on a limb such as an arm or leg (or hand or foot) the user may measure a circumference or radius of the respective limb at the target location. One or more measurements may be used to calculate an approximate depth for insertion of the needle according to the therapy offered and to reach the target muscle or soft tissue. Other factors may be considered by a user to determine a depth and/or duration of needle(s) insertion. The device may then be set to deploy the needle from the device so that as the device is placed against the user's skin, when activated the device will drive or eject the needle into the user's skin. The user then ensures that the needle has been sufficiently inserted before or after removal of the device from the user's skin, leaving the needle behind. In some embodiments the device may have a predetermined limit for linear ejection of the needle and the user may adjust the needle once the needle has been placed.

When ready to dry needle, the user may sanitize the area first and then put the device on or against their limb or body. The user then dispenses one or more needles from the device and into the selected muscle below the device. The user may insert and then immediately remove the needle(s), allowing the needle to momentarily penetrate the muscle or may leave the inserted needle in the muscle for a period of time ranging from about 1 second to about 10 minutes, or for example for about 4 minutes to about 8 minutes, or about 5 minutes, to achieve a therapeutic effect. The user then removes the device from the area of insertion immediately after dispensing and can move the device to a second target area for insertion of a second dry needle.

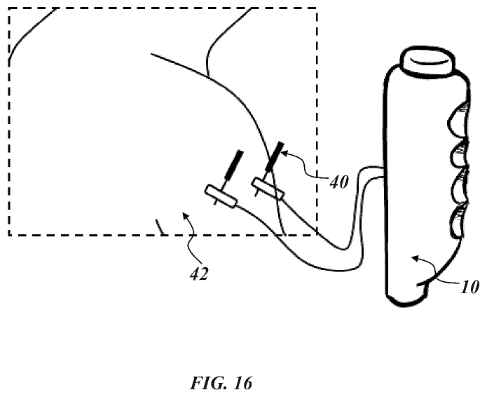

The device according to one or more embodiments described herein may also be operably coupled to a heat source, vibration source, electrical stimulation or pulse source or the like in order to utilize heat, vibration or electrical stimulation with the dispensed needles as shown in FIGS. 15 and 16. That is, the device 10 is configured with one or more sources to transfer heat, vibration and/or electrical stimulation to the dispensed needles 40 as placed in a user 42. The device may have a TENS unit built in allowing the device to place the needles and then connect to the needles in order to deliver heat, vibration and/or electrical pulses thereto.

The device according to one or more embodiments described herein may be dually configured to dispense a needle and then to remove and/or safely dispose of the used needle. In such an embodiment, the device has a retracting mechanism and/or the dispending mechanism may be reciprocally operable to drip, grab or otherwise engage with an end of the needle and retract the needle into the device. The entire device then acts as a sharps handling or disposal device, and is thus safely disposed of after use with the used needles retained within the housing or body of the device. Additionally or alternatively, the device may be a disposable device having a cavity accessible with an inlet which allows a user to remove used needles and place them into the device body for handling and disposal of the used needles.

The device according to one or more embodiments described herein may be used for self-needling and may be used in combination with self-needling devices such as a patch or sleeve described in co-pending application Ser. No. 18/422,639, the contents of which are hereby incorporated in their entirety. The device may be configured to cooperate with the self-needling patch or sleeve including accounting for the thickness of the patch or sleeve and any needle guide therein and donned by the user. That is, the needle outlet of the device would be placed directly against or over an opening in the needle guide of the patch or sleeve or directly against a marked location on the sleeve or patch and held in place while ejecting the needle downwardly through the thickness of the patch or sleeve and into the user's skin the selected depth for therapeutic purposes.

The device according to any one or more embodiments herein may be used with needles provided with or without a sheath.

The devices according to any one or more embodiments described herein can be provided in constructions configured for use on various locations on a user, examples of which include but are not limited to the forearm, shoulder (posterior, anterior, and lateral configurations), thigh (posterior, anterior, and lateral configurations), lower leg (posterior and anterior configurations), back, neck, and foot. The devices described herein can further be used alone or in combination with additional treatments to address contractures and promote movement and blood flow to affected areas.

The devices according to any one or more embodiments described herein are not limited in use to intramuscular stimulation. Embodiments of the devices described herein can be used for reducing the appearance of scars, promoting healing and preventing the formation of scar and scar tissue in the dermal layer, subdermal layer, and/or muscle layer as the device may indicate locations of scar tissue and/or connective tissue of interest for dry needling. Embodiments of the devices described herein may also be used to treat and/or promote healing and/or reduce visible effects of hematomas and other trauma injury sites on a person as well as promote healing of surgical sites not limited to the incision(s). Embodiments of the devices described herein can further be use proximate wounds. Embodiments of the devices described herein can further be applied to target areas comprising stretch marks. In the embodiments here, the locations for needling and needle placement correspond to the condition be addressed.

The devices according to any one or more embodiments described herein are effective in treating and/or minimizing intramuscular pain, muscle tone issues, stiffness, tenderness, tingling and the like. Further, the devices described herein can be used to treat neural tissue and nerves as well as the damage thereto. The needles are positioned with the devices for insertion and to stimulate neural paths and block pain receptors. Dry needling with one or more devices described herein reduces muscle tension, reduces muscle tone, may effectively treat neuromuscular pain syndromes, promote blood and promote healing as noted by any of the uses described herein. The devices described herein may be used for any treatment and/or condition in which dry needling or acupuncture are used. In the case of acupuncture, the needles used with the devices described herein may be a different size, and the device configured dispense needles of one or more sizes such that the devices according to one or more embodiments herein are capable of supporting needles of various sizes.

Although the present disclosure has been described with reference to preferred embodiments, workers skilled in the art will recognize that changes may be made in form and detail without departing from the spirit and scope of the disclosure.

What is claimed:

1. A handheld device for dispensing a plurality of dry needles, the device comprising:
a dry needle outlet end;
a needle priming cavity aligned with an outlet of the needle outlet end and configured to receive a dry needle therein for dispensing;
a needle ejection mechanism comprising a driver configured to eject the dry needle from the needle priming cavity through the needle outlet upon actuation of the needle ejection mechanism; and
a needle storage cavity configured to hold one or more additional dry needles comprising a needle loading mechanism configured to transfer one or more needles from the storage cavity to the needle priming cavity upon actuation of the needle loading mechanism.

2. The device of claim 1 wherein the needle storage cavity is a removable cartridge preloaded with one or more needles and operably couplable to the needle loading mechanism and needle priming cavity.

3. The device of claim 1 wherein the needle storage cavity is a cavity within the handheld device and adjacent the needle priming cavity.

4. The device of claim 1 wherein the needle loading mechanism is a spring activated index to move one dry needle from the needle storage cavity to the needle priming cavity.

5. The device of claim 1 wherein the needle loading mechanism comprises a rotating drum or cylinder holding the one or more dry needles and configured to release one dry needle to the needle priming cavity upon alignment of the rotating drum or cylinder with the needle priming cavity.

6. The device of claim 1 wherein the driver comprises a coil spring, a constant force spring, magnets, a leaf spring, a drive wheel or a combination thereof.

7. The device of claim 1 and further comprising a locking mechanism to prevent dispensing of a dry needle from the dry needle outlet end when the locking mechanism is engaged.

8. The device of claim 1 and further comprising one or more of a heat source, vibration source, or electrical pulse source in the device and connectable to the one or more dry needles ejected from the device.

9. The device of claim 1 wherein the device further comprises a button, knob, lever, trigger or dial for manually activating the driver of the needle ejection mechanism.

10. The device of claim 1 wherein the device further comprises a button, knob, lever, trigger or dial for manually activating the driver of the needle loading mechanism.

11. A method of using a device for injecting a dry needle into the skin for self-needling, the method comprising:
providing a hand-held device storing one or more dry needles therein;
placing the device over a target location on a user;
ejecting one of the one or more dry needles from the hand-held device into a user's skin; and
removing the hand-held device from the target location on the user and leaving the needle behind.

12. The method of claim 11 wherein the device stores at least five needles therein and the method further comprises advancing a subsequent needle for dispensing concurrently or after the ejecting of one of the one or more dry needles.

13. The method of claim 11 and further comprises applying heat, vibration or electrical pulses to the one or more dry needles from a heat, vibration or electrical pulse source in or on the device.
